(19) United States
(12) Patent Application Publication
(10) Pub. No.: US 2015/0113295 A1
(43) Pub. Date: Apr. 23, 2015

(54) RECEIVING INPUT POWER MEASUREMENTS TO MANAGE A RECTIFIER

(71) Applicants: David Paul Mohr, Spring, TX (US); Michael G. Waters, Houston, TX (US); Zachary J. Gerbozy, Spring, TX (US)

(72) Inventors: David Paul Mohr, Spring, TX (US); Michael G. Waters, Houston, TX (US); Zachary J. Gerbozy, Spring, TX (US)

(21) Appl. No.: 14/397,069

(22) PCT Filed: Jul. 31, 2012
(86) PCT No.: PCT/US2012/049038

§ 371 Date: Oct. 24, 2014

(51) Int. Cl. H02M 7/04; G06F 1/26; H02M 1/32

(52) U.S. Cl. CPC H02M 7/04; H02M 1/32; G06F 1/26
USPC 713/300; 363/84; 363/52

(57) ABSTRACT

Examples disclose a controller with a meter interface to receive a first input power measurement provided from a meter. The meter delivers input power to a rectifier which delivers power to a load. Additionally, the examples disclose the controller with a rectifier interface to receive a second input power measurement provided from the rectifier. Further, the examples disclose the controller to manage the rectifier based on the first and the second input power measurements.

### BACKGROUND

Power distribution systems are utilized in a traditional data center which houses numerous racks of servers and other electronic devices for networking. As such, the space within the data center may be limited, increasing dependence on providing reliability and efficiency within the power distribution systems.

### BRIEF DESCRIPTION OF THE DRAWINGS

In the accompanying drawings, like numerals refer to like components or blocks. The following detailed description references the drawings, wherein:

FIG. 1 is a block diagram of an example controller with a meter interface and a rectifier interface to receive from a meter a first input power measurement and from a rectifier a second input power measurement to manage the rectifier based on the input power measurements;

FIG. 2 is a block diagram of an example controller including a meter interface to receive from a meter a first input power measurement, a rectifier interface to receive from a rectifier a second input power measurement to manage the rectifier based on the input power measurements, a rack interface, a management interface to deliver a notification, and a circuit protection interface to protect the rectifier;

FIG. 3 is a block diagram of an example power system including a meter, a rectifier, protection module to provide power to a load, a controller to manage the rectifier and the meter based on input power measurements, and a management module to communicate a notification; and

FIG. 4 is a flowchart of an example method performed on a computing device to set a threshold amount of power on a meter, receive a first and a second power measurement to manage a rectifier, and determine whether the meter is above or below a threshold to detect a fault within the meter.

### DETAILED DESCRIPTION

Providing reliability and efficiency within a power distribution system protects servers and electronic components within the data center from power disruptions which may potentially cause data loss and/or business disruption. One solution provides a server system (i.e., multiple servers) with a redundant power supply. This solution detects a fault within one of the power supplies and manages the power supplies in the system by alternating power to the other power supply. For example, the solution may detect a near fault in one power supply and utilizes switches within the power supplies to alternate the power supplied to the server system. However, this solution is limited with regards to the management of the resources. Additionally, the system is without protection in the situations of overdrawing power or a short circuit, thus potentially causing a server disruption.

In another solution, a single server with interfaces communicates with multiple power supplies to recognize faults within each of the supplies. In this solution, the server interfaces may detect the fault within one of the supplies and communicate to the switches within the power supplies to connect and/or disconnect. However, this solution is also limited of the type of management as it manages switches to turn the power supplies on and off once the fault is detected. Additionally, neither solution is efficient as multiple power supplies take much space, resources, and energy to operate. Further, both of these solutions are without effective management of the resources in the power system.

To address these issues, example embodiments disclosed herein provide a controller with a meter interface to receive a first input power measurement from a meter which delivers input power to a rectifier. The meter measures the amount of power received from a power feed into the system. Receiving the input power measurement from the meter enables the controller to monitor and track the input power. For example, the input power from the power feed may suffer a failure and as such, the controller may detect this failure.

Additionally, this example embodiment provides the controller with a rectifier interface to receive a second input power measurement from the rectifier to manage the rectifier based on the first and the second power measurements. The rectifier delivers power to a load, such as server racks. The controller managing the rectifier based on the input power measurements increases reliability and efficiently by managing resources within a power system. For example, receiving power measurements enables the controller to determine if within a system receiving multiple power feeds, which input may have power issues and thus reduce or increase power delivered to the load from that part of the system through the rectifier. Additionally, managing the rectifier based on the input power measurements, enables the controller to manage the resources at the rack level which facilitates safety. For example, the rack level may manage the resources may include at a lower voltage than when distributing a higher voltage to the load. Further, this embodiment also reduces the amount of space within the power system as the ability of the controller to manage the rectifier based on power measurements and decreases the need of a redundant power supply.

In another embodiment, a management interface provides a notification associated with the input power measurements to an administrator. Providing notification provides another level of management as in this embodiment, the administrator may set a threshold of power for each component communicating with the controller so the controller may signal the management interface to send a notification when the threshold is too high or too low.

In a further embodiment, an example embodiment provided herein provides a circuit protection interface which provides power from the rectifier to the load and protects the rectifier by preventing the overdraw of power from the load. Additionally, the controller manages the circuit protection through the use of a circuit breaker.

Yet in a further embodiment, the rectifier provides power to the controller for operation. This provides additional efficiency as the controller may receive the power from the rectifier rather than from an additional power supply which thus decreasing the space of the system and use of resources.

In summary, example embodiments disclosed herein provide managing resources within a power system to increase reliability and efficiency to deliver power to a server system. Further, the example embodiments disclosed herein decrease the cost and space of the power system as it reduces the redundancy of the components.

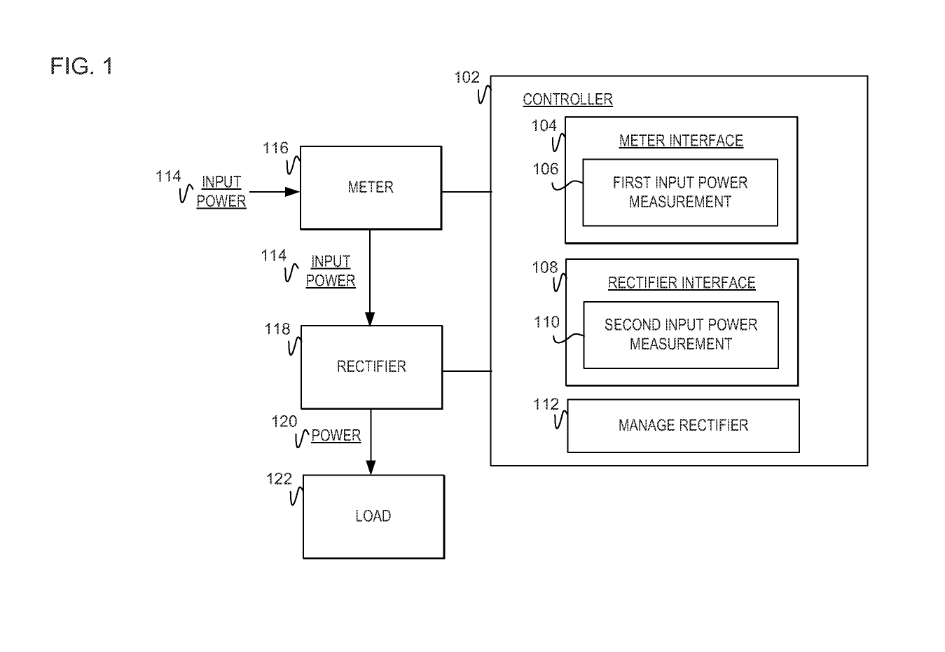

Referring now to the drawings, FIG. 1 is a block diagram of an example controller 102 with a meter interface 104 to receive from a meter 116 a first input power measurement 106 and a rectifier interface 108 to receive from a rectifier 118 a second power measurement 110. Additionally, the controller 102 manages the rectifier at module 112 based on the input power measurements 106 and 110. The meter 116 receives input power 114 from a power feed and delivers to the rectifier 118. The rectifier 118 receives the input power 114 and delivers power 120 to a load 122. Embodiments of the controller 102 include a microchip, chipset, electronic circuit, processor, microprocessor, semiconductor, microcontroller, processor, central processing unit (CPU), graphics processing unit (GPU), visual processing unit (VPU), or other programmable device capable including the meter interface 104 and the rectifier interface 108 and receiving the input power measurements 106 and 110.

The meter interface 104 receives the first input power measurement 106 from the meter 116. The meter interface 104 is a type of communication between the controller 102 and the meter 116. In this embodiment, the controller 102 communicates with the meter 116 by transmitting and receiving bits, data, and/or signals to the meter 116 through the meter interface 104 to obtain the first input power measurement 106. For example, the controller 102 may send a communication through the meter interface 104 to the meter 116 requesting the first input power measurement 106, while the meter 116 may transmit the measurement 106 in response. In another embodiment, the meter interface 104 is one type of communication interface while the rectifier interface 108 is a second type of communication interface. For example, the meter interface 104 may include a serial peripheral interface while the rectifier interface may include a two-wire interface. Embodiments of the meter interface 104 include a two-wire interface, serial peripheral interface, synchronous serial data interlace, serial data interface, parallel data interface, universal asynchronous data interface, or other type of communication interface capable of communicating between the controller 102 and the meter 116.

The first input power measurement 106 is a power (i.e., energy) measurement of the input power 114 as measured by the meter 116 and communicated through the meter interface 104 to the controller 102. As such, the first input power measurement 106 is a communication by a signal, bit, or data representing the magnitude of the input power 114. Embodiments of the first input power measurement 106 include a current measurement, voltage measurement, potential measurement, energy measurement, electrical charge measurement, or other type of power measurement communicated through the meter interlace 104 to the controller 102.

The rectifier interface 108 receives the second input power measurement 110 from the rectifier 118. The rectifier interface 108 is a type of communication interface between the controller 102 and the rectifier 118. In this embodiment, the controller 102 communicates with the rectifier 118 by transmitting and receiving bits, data, and/or signals to the rectifier 118 through the rectifier interface 108 to obtain the second input power measurement 110. Embodiments of the rectifier interface 108 include a two-wire interface, serial peripheral interface, synchronous serial data interface, serial data interface, parallel data interface, universal asynchronous data interface, or other type of communication interface capable of communicating between the controller 102 and the rectifier 118.

The second input power measurement 110 is a communication that may include a bit, data, and/or signal to the controller 102 through the rectifier interface 102 representing the magnitude of the power internal to the rectifier 118. In this embodiment, the second input power measurement 110 provides a redundant power measurement to the controller 102. This redundant power measurement 110 enables the controller 102 to determine if there may be power issues in the meter 116, input power 114, or the rectifier 118. The second input power measurement 110 may be similar in structure of the first input power measurement 106 and as such, embodiments of the second input power measurement 110 include a current measurement, voltage measurement, potential measurement, energy measurement, electrical charge measurement, or other type of power measurement communicated through the rectifier interface 108 to the controller 102.

At module 112, the controller 102 manages the rectifier 118 based on the input power measurements 106 and 110. In one embodiment of module 112, the controller 102 manages the rectifier 118 by performing at least one of: disabling through a switch (not illustrated) within the rectifier 118, adjusting the input power 114 higher or lower provided to the rectifier 118 through an electrical device (not illustrated), detecting a power failure within the rectifier 118, and monitoring a status of the rectifier 118. For example, the controller 102 may detect the power failure in the rectifier 118 based on comparing the first input power measurement 106 which includes no power failure issues to the second input power measurement 110 which may indicate a high or low power measurement within the rectifier 118. Accordingly, the controller 102 may respond to the power failure issue within the rectifier 118 by decreasing the amount of input power 114 delivered to the rectifier 118 and/or disconnecting the rectifier 118 from the meter 116. This embodiment is described in detail in later figures. Embodiments of the module 112 include a set of instructions, instruction, process, operation, logic, algorithm, technique, logical function, firmware, and or software executable by the controller 102 to manage the rectifier based on the input power measurements 106 and 110.

The input power 114 provides electrical energy through the meter 116 to the rectifier 118 to supply the load 122. The input power 114 provides energy to components within a power system, such as the controller 102, in order to perform various tasks, such as dock speeds or logical functions. The input power 114 is provided from a source, power feed, power supply, generator, power circuit, energy storage, electromechanical system or other type of power source capable of supplying electrical energy through the meter 116. Embodiments of the input power 114 include watts, current, electrical change, watts, alternating current, direct current, voltage, analog voltage, digital voltage, or other type energy capable of being supplied to the rectifier 118 through the meter 116.

The meter 116 is an electrical component which measures the amount of electrical energy delivered to the rectifier 118 over time. As indicated in FIG. 1, the arrows depict the flow of the input power 114 from the meter 116 to the rectifier 118 while the line connecting the meter 116 to the controller 102 depicts the communication connection. Embodiments of the meter 116 include a voltmeter, ohmmeter, multi-meter, electromechanical meter, electricity meter, power meter, or other type of electrical component capable of measuring the input power 114 and communicating with the controller 102.

The rectifier 118 is an electrical component that converts energy from one form of energy to another form of energy. Specifically, the rectifier 118 manages the input power 118 to convert to the power 120 and further providing the power 120 to flow in the direction to the load 122. The load 122 may include one or more servers receiving power 120 from the rectifier 118. In one embodiment, the rectifier 118 provides power to the controller 102 for the controller to operate. This enables the rectifier 118 to supply the stand-up power for the operation of the controller 102 which reduces the space constraints as it reduces the need for a separate power supply to power the controller 102. This embodiment is described in detail in later figures. In another embodiment, the rectifier 118 converts alternating current to direct current. As indicated in FIG. 1, the arrows depict the flow of the input power 114 and power 120 from the rectifier 118 to the load 122 while the line connecting the rectifier 118 to the controller 102 depicts the communication connection. Embodiments of the rectifier 118 include a semiconductor diode, vacuum tube, thryristor, solid-state switch, or other type of rectification component to receive input power 114 and deliver power 120.

The power 120 is a result of a conversion of the input power 114 received at the rectifier 118. In one embodiment, the input power 114 is converted from analog voltage to digital voltage at the rectifier 118 to provide the power 120 to the load 122.

In another embodiment, the input power 114 is converted from alternating current to direct current to provide power 120 to the load 122, Embodiments of the power 120 include watts, current, electrical change, watts, alternating current, direct current, voltage, analog voltage, digital voltage, or other type energy capable of being supplied to the load 122.

The load 122 receives power 120 from the rectifier 113. In one embodiment, the load 122 includes rack enclosure of servers receiving power 120 from the rectifier 118. In this embodiment, the power 120 is collected from one or more rectifiers 118 to supply the load 122. In another embodiment, the load 122 includes a power booster to increase the power 120 received from the rectifier 118 and distributed to the load 122. Embodiments of the load 122 include an electrical circuit, electrical impedance, servers, computing devices, or other type of circuit capable of receiving power 120 from the rectifier 118.

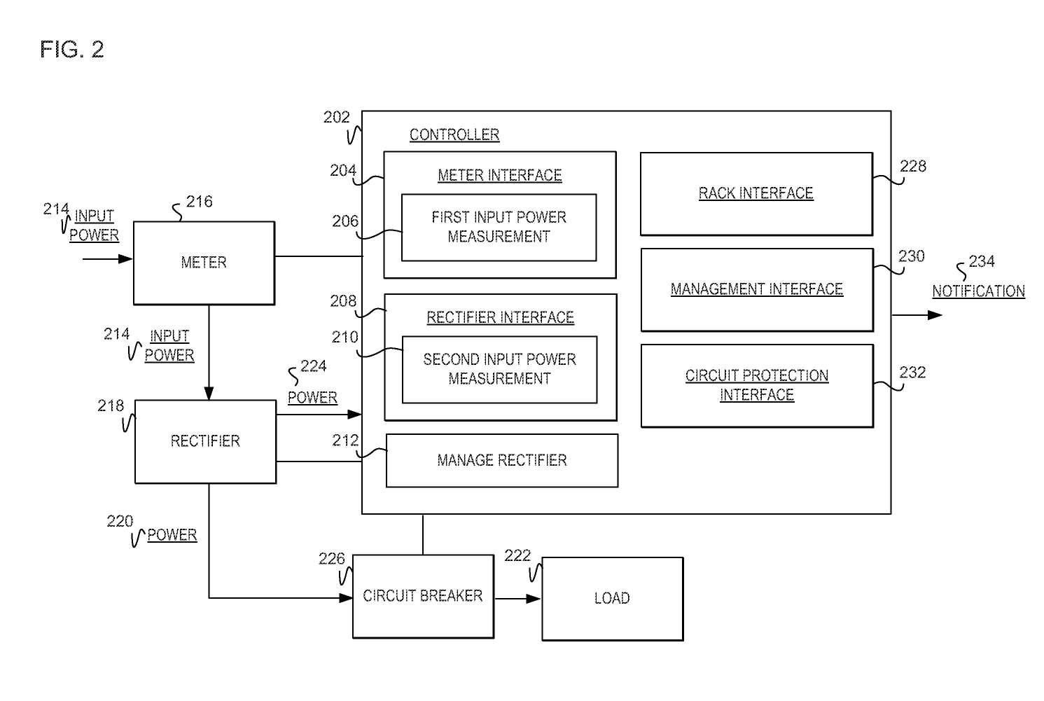

FIG. 2 is a block diagram of an example controller 202 including a meter interface 204 to receive from a meter 216 a first input power measurement 206, a rectifier interface 208 to receive from a rectifier 218 a second input power measurement 210 to manage the rectifier 218 at module 212 based on the input power measurements 206 and 210. Additionally, the controller 202 includes a rack interface 228 to locate a physical position of the components in communication with the controller 202, a management interface 230 to deliver a notification 234, and a circuit protection interface 232 to protect the rectifier 218 through the circuit breaker 226. The controller 202 may be similar in structure and functionality to the controller 102 as in FIG. 1.

The meter 216 receives the input power 214 to deliver the first input power measurement 206 to the meter interface 204. The meter 216, the input power 214, the first input power measurement 206, and the meter interface 204 are similar in structure and functionality to the meter 116, the input power 114, the first power measurement 106, and the meter interface 104 as in FIG. 1.

The rectifier 218 receives the input power 214 through the meter 216 to transmit the second input power measurement 210 to the rectifier interface 208. Additionally, the rectifier 218 delivers power 220 to the circuit breaker 226. Further, the rectifier 218 may include a second output to provide power 224 to the controller 202 for operation, The rectifier 218, the second input power measurement 210, the rectifier interface 218, and the power 220 may be similar in structure and functionality to the rectifier 118, the second input power measurement 110, the rectifier interface 108, and the power 120 as in FIG. 1.

The module 212 manages the rectifier based on the first and the second input power measurements 206 and 210. The module 212 may be similar in functionality to the module 112 as in FIG. 1.

The power 224 is provided to the controller 202 for operational tasks performed by the controller 202 once the rectifier 218 receives the input power 214. For example, the rectifier 218 may further provide power 224 to the controller 202 for operational tasks such as executing instructions and/or logical functions. In this embodiment, the power 224 operates as a standby power supply, thereby reducing the size of the power system by diminishing the need of a separate power supply to provide power to the controller 202. Rather, the rectifier 218 supplies the power 224 as received from the input power 214. Although in FIG. 2, the power 224 and power 220 are illustrated as two different outputs provided to the controller 220 and the circuit breaker 226, embodiments should not be limited to this illustration as the power 220 may be provided from the same output as the power 224. The power 224 may be similar in structure and functionality to the power 220 and as such, embodiments of the power 224 include watts, current, electrical change, watts, alternating current, direct current, voltage, analog voltage, digital voltage, or other type energy capable of being supplied to the controller 202 for operation.

The rack interface 228 is a communication interface which tracks a physical location within a server rack of each component 216, 218, and 226 in communication to each controller interface 204, 208, 228, 230, and 232. Additionally, the rack interface 228 communicates with the management interface 230 to provide the physical locations of the components 216, 218, and 226 as part of the notification 234 to an administrator, In this embodiment, the notification 234 may include the physical location of the component 216, 228, or 226 within the system that is above or below a threshold amount of power. For example, the notification 234 helps describe and/or identify the shelf locations of each component 216, 218, or 226 within a rack of servers to communicate to the administrators the physical locations of the components 216, 218, or 226 that may experience power issues. Additionally, this embodiment provides additional management of the resources so the administrator may monitor and track the on-goings of the components 216, 218, or 226. Embodiments of the rack interface 228 include a two-wire interface, serial peripheral interface, synchronous serial data interface, serial data interface, parallel data interface, universal asynchronous data interface, or other type of communication interface capable of tracking the physical location of each component within the server system.

The management interface 230 is a type of communication interface with the controller 202 to provide the notification 234 associated with the input power measurements 206 and 210 to the administrator. Providing the notification 234 to the administrator enables a tracking of the components, such as the meter 216, rectifier 218, circuit breaker 226, and/or each server within the load 222. This also provides additional management of the components to the administrator. Embodiments of the management interface 230 a two-wire interface, serial peripheral interface, synchronous serial data interface, serial data interface, parallel data interface, universal asynchronous data interface, or other type of communication interface capable of providing the notification 234 to the administrator.

The notification 234 is a communication displayed and/or presented to the administrator. The notification 234 alerts the administrator if a component, such as the meter 216, rectifier 218, circuit breaker 226, etc. may be above or below a threshold amount of power. This allows the administrator to track and monitor various statuses of the components 216, 218, and 226 such as a power failure within the component. In another embodiment, the notification 234 may include data about the servers within the load 222, and may also the physical locations of each of the servers within the load 222. In a further embodiment, the notification 234 includes power utilization data of one or more components 216, 218, and 226. Embodiments of the notification 234 include an email, user interface, visual display, audio that communicates to the administrator the status of one or more components 216, 218, and 226.

The circuit protection interface 232 communicates with the circuit breaker 226 to receive power 220 from the rectifier 218 and provide to the load 222. Additionally, the circuit protection interface 232 protects the rectifier 218 by disconnecting the rectifier 218 from the load 222 through the circuit breaker 226. In this embodiment, disconnecting a switch within the circuit breaker 226 protects the rectifier 218 and other components from the situations of overdrawing power or a short circuit within the load 222. Specifically, the controller 202 may communicate with the circuit breaker 226 through the circuit protection interface 232 to protect the rectifier 218 by disconnecting the switch within the circuit breaker 226, thus interrupting the flow of power to the load 222. Embodiments of the circuit protection interface 232 include a two-wire interface, serial peripheral interface, synchronous serial data interface, serial data interface, parallel data interface, universal asynchronous data interface, or other type of communication interface capable of communicating with the circuit breaker 226.

The circuit breaker 226 is electrical component between the rectifier 218 and the load 122. Specifically, the circuit breaker 226 functions to disconnect and/or connect by interrupting or continuing the electrical flow of the power 220 to the load 222. In this embodiment, the circuit breaker 226 may be used to protect the rectifier 218 and other electrical components from suffering damage caused by an overload or short circuit in the load 222. Additionally, the circuit breaker 226 communicates with the controller 202 through the circuit protection interface 232 to interrupt and/or continue the flow of the power 220 to the load 222. Embodiments of the circuit breaker 226 include a switch, electrical circuit, semiconductor, relay, residual-current device, autorecloser, or other type of electrical component capable of interrupting the flow of the power 220 to the load 222.

The load 222 connected to the circuit breaker 226 distributes power 220 to one or more servers within a rack. The load 222 may be similar in structure and functionality to the load 122 as in FIG. 1.

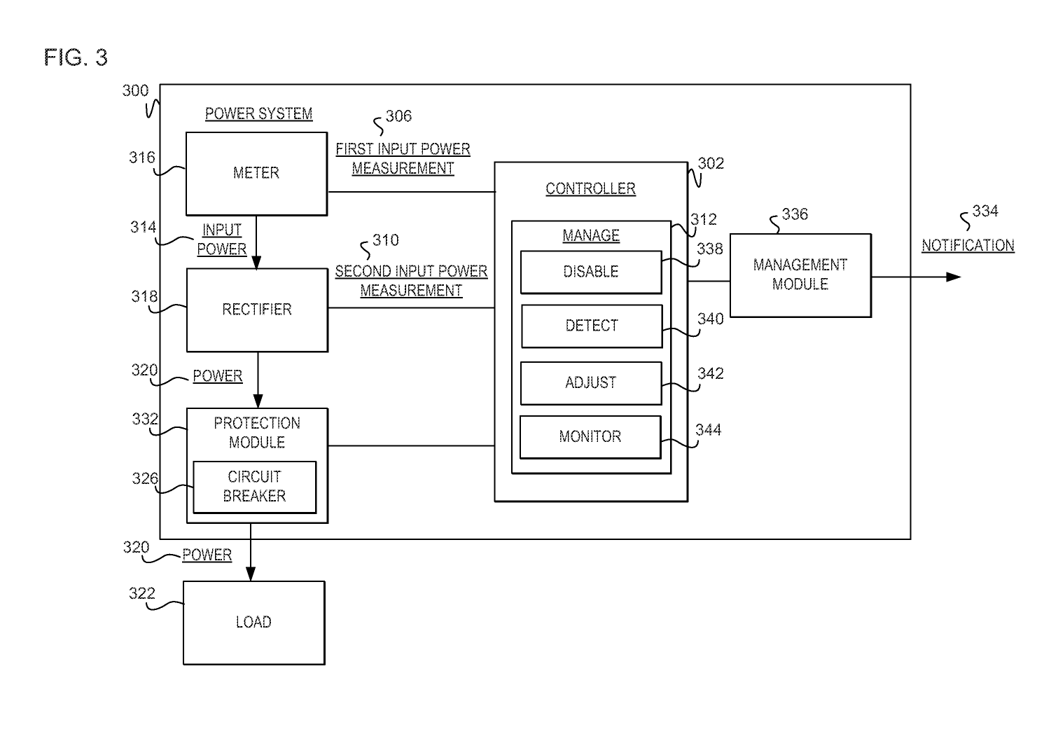

FIG. 3 is a block diagram of an example power system 300 including a meter 316, a rectifier 318, and a protection module 332 to provide power 320 to a load 322. Additionally, the system 300 includes a controller 302 to manage at module 312 the rectifier 318 and the meter 316 and a management module 336 to communicate a notification 334 to an administrator. In one embodiment, the power system 300 is located in a shelf of a server rack while the load 322 includes one or more servers. Embodiments of the power system 300 include a distribution system, server system, networking system, or other type of power system 300 suitable for including the meter 316, the rectifier 318, the protection module 332, and the controller 302.

The meter 316 and the rectifier 318 receive input power 314 and communicate the first input power measurement 306 and the second power measurement 310 to the controller 310. Additionally, the rectifier 318 receives the input power 314 and converts the input power 314 to the power 320. The meter 316, the rectifier 318, the input power 314, the first input power measurement 306, and the second input power measurement 310, and the controller 302 may be similar in structure and functionality to the meter 116 and 216, the rectifier 118 and 218, the input power 114 and 214, the first input power measurement 106 and 206, and the second input power measurement 110 and 210, and the controller 102 and 202 as in FIGS. 1-2.

The power 320 is transmitted by the rectifier 318 through the protection module 332 including the circuit breaker 326 and delivered to the load 322. The power 320, the protection module 332, the circuit breaker 326, and the load 322 may be similar in structure and functionality to the power 120 and 220, the circuit protection interface 232, the circuit breaker 226, and the load 122 and 222 as in FIGS. 1-2.

The module 312 manages the rectifier 318 and/or the meter 316 by performing one of the modules 338-344 based on the input power measurements 306 and 310. The input power measurements 306 and 310 may indicate which module 338-344 should be performed by the controller 302. In this embodiment, the management of the rectifier 318 and/or the meter 316 is based on the input power measurements 306 and 310. For example, the controller 302 may detect a power failure at module 340 within the meter 316 and/or rectifier 318 by comparing input power measurements 306 and 310. Embodiments of modules 312 and 338-344 include a set of instructions, instruction, process, operation, logic, algorithm, technique, logical function, firmware, and or software executable by the controller 302 to manage the meter 316 and/or the rectifier 318 based on the input power measurements 306 and 310.

The module 338 disables the rectifier 318 and/or the meter 316 based on the input power measurements 306 and 310. In this embodiment, the input power measurements 306 and 310 are compared to each other to isolate a power issue within the meter 316 and/or the rectifier 318 for disabling from the power system 300. This isolates the power issue to one of the components 316, 318, or 326 preventing damage to other components within the system 300.

The module 340 detects a power failure within the rectifier 318 and/or the meter 316. In this embodiment, one or both of the input power measurements 306 and 310 may measure higher or lower than a threshold amount of power, indicating the power failure within the rectifier 318 and/or the meter 316. In another embodiment, an administrator inputs the threshold amount of power prior to the power system 300 operating. For example, the administrator may input a maximum power measurement and a minimum power measurement for each of the components 316, 318, and 326 in the power system 300. In a further embodiment, once one of the components 316, 318, or326 reach above or below the threshold amount of power, the controller 302 communicates with the management module 336 to transmit the notification 334 to the administrator.

The module 342 adjusts the input power 314 from the meter 316 provided to the rectifier 318. In this embodiment, the controller 302 may adjust the input power 314 higher or lower to the rectifier 318. Additionally, in this embodiment, if the system 300 has more than one rectifier 318, the input power 314 delivered to one of the rectifiers 318 may be lower than the input power 314 delivered to the other rectifiers 318. This enables the controller 302 to skew and adjust the input power 314 to the rectifier 318.

The module 344 monitors a status of the rectifier 318. The status of the rectifier 318 describes a state or condition the rectifier 318 may be operating in. In this embodiment, the rectifier 318 and/or the meter 316 may be close to experiencing a power issue, thus the controller 302 monitors the rectifier 318 and the meter 316 through the input power measurements 306 and 310.

The management module 336 communicates a notification 334 to an administrator. The management module 336 and the notification 334 may be similar in structure and functionality to the management interface 230 and the notification 234 as in FIG. 2.

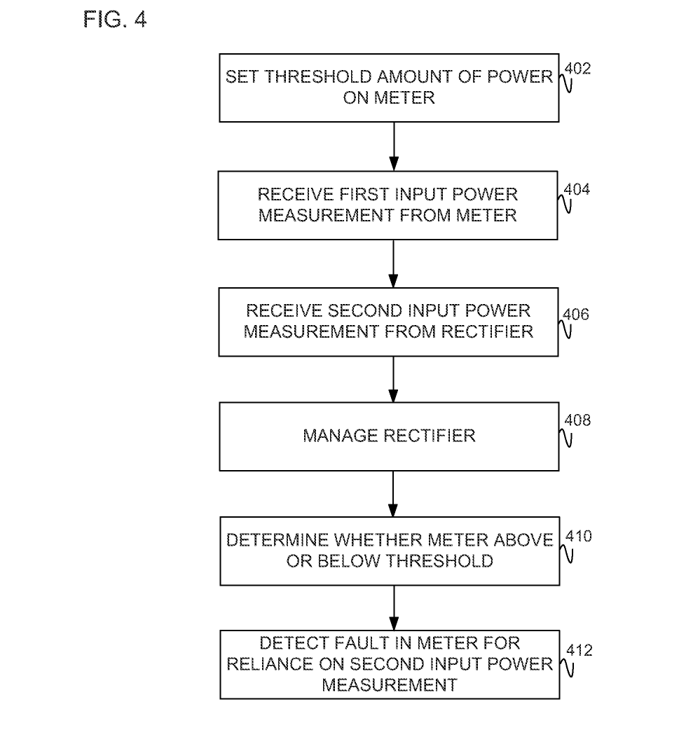

FIG. 4 is a flowchart of an example method performed on a computing device to set a threshold amount of power on a meter, receive a first and a second power measurement to manage a rectifier, and determine whether the meter is above or below a threshold to detect a fault within the meter, Although FIG, 4 is described as being performed on the computing device, it may also be executed on other suitable components as will be apparent to those skilled in the art. For example, FIG. 4 may be implemented in the form of executable instructions stored on a machine-readable storage medium or on a controller 102, 202, and 302 as in FIGS. 1-3 or in the form of electronic circuitry.

At operation 402, a threshold amount is set on the meter. In another embodiment, a threshold amount of power may be set on other component within the system. For example, this may include setting a threshold amount of power on the rectifier such as 118, 218, and 318 as in FIGS. 1-3.

At operation 404 a controller within the computing device receives a first input power measurement from a meter. In one embodiment, operations 404 and 406 occur in dose proximity to deliver input power measurements to the controller. In another embodiment, operation 404 includes a meter interface (Le., communication interface) as part of the controller receiving the first input power measurement.

At operation 406 the controller receives the second input power measurement from the rectifier. In one embodiment, operation occurs once operation 404 is performed. In another embodiment, operation 406 includes a rectifier interface as part of the controller receiving the second input power measurement. In a further embodiment, operation 406 includes comparing, analyzing, and/or processing the input power measurements received at operations 404-406.

At operation 408, the controller manages the rectifier based on the input power measurements received at operations 404 and 406. In one embodiment of operation 408, the controller performs at least one of detecting a power failure within the rectifier, disabling the rectifier from a power system, adjusting input power to the rectifier, and monitoring a status of the rectifier.

At operation 410 the controller determines whether the input power measurement received at operation 404 is above or below the threshold amount of power as set at operation 402. In one embodiment, operation 410 includes sending a notification to an administrator.

At operation 412 the controller detects a fault within the meter and relies on the second input power measurement as at operation 406. In this embodiment, the controller may disregard the first input power measurement as received at operation 404 and rely on the second input power measurement as received at operation 406 to manage the rectifier. In one embodiment, the fault is detected based on whether the meter was above or below a threshold amount of power as at operation 410.

In summary, example embodiments disclosed herein provide managing resources within a power system to increase reliability and efficiency to deliver power to a server system. Further, the example embodiments disclosed herein decrease the cost and space of the power system as it reduces the redundancy of the components.

We claim:

1. A controller comprising:
a meter interface to receive a first input power measurement provided from a meter, the meter delivers input power to a rectifier, the rectifier delivers power to a load; and
a rectifier interface to receive a second input power measurement provided from the rectifier, the controller manages the rectifier based on the first and the second input power measurements.

2. The controller of claim 1 further comprising:
a management interface to provide a notification associated with the input power measurements received by the controller to an administrator.

3. The controller of claim 2 further comprising:
a rack interface to track a physical location within a server rack of each component connected to each controller interface, the rack interface to communicate with the management interface to provide the notification to the administrator.

4. The controller of claim 1 further comprising:
a circuit protection interface to provide the power from the rectifier to the load and to protect the rectifier by preventing overdraw of the power by the load, the controller manages the circuit protection interface through a circuit breaker.

5. The controller of claim 1 wherein the rectifier further provides power to the controller for operation.

6. The controller of claim 1 wherein the meter interface is one type of communication interface and the rectifier interface is a second type of communication interface.

7. The controller of claim 1 wherein the controller manages the rectifier by performing at least one of: disabling the rectifier, adjusting the input power provided from the meter to the rectifier, detecting a power failure within the rectifier, and monitoring a status of the rectifier.

8. A power system comprising:
a meter to communicate a first input power measurement to a controller, the meter delivers an input power to a rectifier;
the rectifier to communicate a second input power measurement to the controller, the rectifier delivers power to a load; and
the controller to manage the rectifier and the meter based on the input power measurements.

9. The power system of claim 8 further comprising:
a management module to communicate with the controller and transmit a notification corresponding to the input power measurements to an administrator, the notification transmitted when one of the components within the power system is above or below a threshold amount of power.

10. The power system of claim 8 further comprising:
a protection module to communicate with the controller and to protect the power system, the protection module detects a fault within the power system and interrupts power to the load by the rectifier through a circuit breaker.

11. The power system of claim 8 wherein the power system is located in a shelf of a server rack and the load includes a server.

12. A method for a power distribution system comprising:
receiving a first input power measurement from a meter, the meter delivers input power to a rectifier;
receiving a second input power measurement from the rectifier, the rectifier delivers output power to a server;
based on the power measurements, managing the rectifier.

13. The method of claim 12 further comprising:
detecting a fault within the meter for further reliance on the second input power measurement from the rectifier to manage the rectifier.

14. The method of claim 12 further comprising:
setting a threshold amount of power on the meter;
determine whether the meter is above or below the threshold amount of power to transmit a notification to an administrator.

15. The method of claim 12 wherein managing the rectifier includes at least one of:
disabling the rectifier;
adjusting the input power to the rectifier from the meter;
detecting a power failure within the rectifier; and
monitoring a status of the rectifier.
